(19) United States
(12) Patent Application Publication
(10) Pub. No.: US 2020/0164505 A1
(43) Pub. Date: May 28, 2020

(54) Training for Robot Arm Grasping of Objects

(71) Applicant: Osaro, San Francisco, CA (US)

(72) Inventors: Sebastiaan Boer, San Francisco, CA (US); Alex Kuefler, London (GB); Jun Yu, San Francisco, CA (US)

(21) Appl. No.: 16/697,597

(22) Filed: Nov. 27, 2019

Related U.S. Application Data
(60) Provisional application No. 62/771,622, filed on Nov. 27, 2018.

(51) Int. Cl. B25J 9/16; G06N 3/04; G06T 7/70; G06T 7/00

(52) U.S. Cl. CPC B25J 9/163; G06N 3/04; B25J 9/1661; B25J 9/1664; G06T 2207/20084; G06T 7/70; G06T 7/0002; G06T 2207/10028; B25J 9/1697

(57) ABSTRACT

A computer system learns how to grasp objects using a robot arm. The system generates masks of objects shown in an image. A grasp generator generates proposed grasps for the objects based on the masks. A grasp network evaluates the proposed grasps and generates scores representing the likelihood that the proposed grasps will be successful. The system makes an innovative use of masks to generate high-quality grasps using fewer computations than existing systems.

### BACKGROUND

The benefits of enabling robot arms to grasp objects are well known, and various technologies exist for enabling such grasping. In general, for a robot arm with two fingers to grasp an object, it is necessary for the arm to be in a pose and have a gripper width such that closing the gripper in that pose will result in a grasp around the object that is firm enough to enable the robot arm to move the object without dropping the object.

Existing machine learning-based techniques for addressing the robot arm grasping problem generally fall into two broad categories:
(1) Supervised learning (SL) methods, which require humans to provide annotations (labels) on images of objects. Those annotations indicate how the objects should be grasped by the robot arm gripper. Such annotations may, for example, indicate the positions on which the gripper fingers should grip the object. A model (such as a neural network) is then trained to output “grasps” (e.g., robot finger positions) which are similar to the human-provided labels.
(2) Reinforcement learning (RL) methods, in which a robot attempts to grasp objects and then learns from its successes and failures. For example, the positions (e.g., poses and gripper finger locations) which resulted in successful grasps (e.g., grasps which did not result in dropping the object while moving it) may have positive reinforcement applied to them, while the positions which resulted in unsuccessful grasps (e.g., grasps which did not successfully pick up the object or which resulted in dropping the object while moving it) may have negative reinforcement applied to them.

SL methods are limited by the fact that human labelers may not be able to intuit the best way of picking up an object just by looking at an image of the object. As a result, the human-generated labels that drive SL methods may be suboptimal, and thereby result in suboptimal grasps. RL methods are limited by the fact that many grasps, which may be time-consuming and expose the robot to wear and tear, must be attempted before learning can occur.

What is needed, therefore, are improved techniques for enabling robot arms to grasp and move objects.

### SUMMARY

A computer system learns how to grasp objects using a robot arm. The system generates masks of objects shown in an image. A grasp generator generates proposed grasps for the objects based on the masks. A grasp network evaluates the proposed grasps and generates scores representing the likelihood that the proposed grasps will be successful. The system makes an innovative use of masks to generate high-quality grasps using fewer computations than existing systems.

One aspect of the present disclosure relates to a system configured for generating and evaluating a first plurality of proposed grasps corresponding to a first object, the. The system may include one or more hardware processors configured by machine-readable instructions. The processor(s) may be configured to receive a input image representing the first object. The processor(s) may be configured to receive an aligned depth image representing depths of a plurality of positions in the input image. The processor(s) may be configured to generate, based on the input image and the aligned depth image, a first mask corresponding to the first object. The processor(s) may be configured to generate, based on the first mask, the first plurality of proposed grasps corresponding to the first object. The processor(s) may be configured to generate, based on the first plurality of proposed grasps, a first plurality of quality scores corresponding to the first plurality of proposed grasps. The first plurality of quality scores may represent a first plurality of likelihoods of success corresponding to the first plurality of proposed grasps.

In some implementations of the system, the input image may further represent a second object. In some implementations of the system, generating, based on the input image and the aligned depth image, a first mask may correspond to the first object further includes generating, based on the input image and the aligned depth image, a second mask corresponding to the second object. In some implementations of the system, generating, based on the first mask, the first plurality of proposed grasps corresponding to the first object further includes generating, based on the second mask, a second plurality of proposed grasps corresponding to the second object. In some implementations of the system, generating, based on the first plurality of proposed grasps, a first plurality of quality scores corresponding to the first plurality of proposed grasps may further include generating, based on the second plurality of proposed grasps, a second plurality of quality scores corresponding to the second plurality of proposed grasps. In some implementations of the system, the second plurality of quality scores may represent a second plurality of likelihoods of success corresponding to the second plurality of proposed grasps.

In some implementations of the system, each grasp, in the first plurality of proposed grasps, may include data representing a pair of pixels in the input image corresponding to a first and second position, respectively, for a first and second gripper finger of a robot.

In some implementations of the system, generating, based on the input image and the aligned depth image, a first mask corresponding to the first object may include generating, based on the input image and the aligned depth image, a plurality of regions of interest in the input image. In some implementations of the system, generating, based on the input image and the aligned depth image, a first mask corresponding to the first object may include generating the first mask based on the plurality of regions of interest in the input image.

In some implementations of the system, generating the first mask based on the plurality of regions of interest in the input image may include using a convolutional neural network to generate the first mask based on the plurality of regions of interest in the input image.

In some implementations of the system, generating, based on the first plurality of proposed grasps, a first plurality of quality scores corresponding to the first plurality of proposed grasps may include generating, based on the input image, a feature map. In some implementations of the system, generating, based on the first plurality of proposed grasps, a first plurality of quality scores corresponding to the first plurality of proposed grasps may include generating the first plurality of quality scores based on the feature map and the plurality of regions of interest in the input image.

In some implementations of the system, generating, based on the input image, a feature map may include using a convolutional neural network to generate the feature map.

Another aspect of the present disclosure relates to a method for generating and evaluating a first plurality of proposed grasps corresponding to a first object, the. The method may include receiving a input image representing the first object. The method may include receiving an aligned depth image representing depths of a plurality of positions in the input image. The method may include generating, based on the input image and the aligned depth image, a first mask corresponding to the first object. The method may include generating, based on the first mask, the first plurality of proposed grasps corresponding to the first object. The method may include generating, based on the first plurality of proposed grasps, a first plurality of quality scores corresponding to the first plurality of proposed grasps. The first plurality of quality scores may represent a first plurality of likelihoods of success corresponding to the first plurality of proposed grasps.

Yet another aspect of the present disclosure relates to a non-transient computer-readable storage medium having instructions embodied thereon, the instructions being executable by one or more processors to perform a method for generating and evaluating a first plurality of proposed grasps corresponding to a first object, the. The method may include receiving a input image representing the first object. The method may include receiving an aligned depth image representing depths of a plurality of positions in the input image. The method may include generating, based on the input image and the aligned depth image, a first mask corresponding to the first object. The method may include generating, based on the first mask, the first plurality of proposed grasps corresponding to the first object. The method may include generating, based on the first plurality of proposed grasps, a first plurality of quality scores corresponding to the first plurality of proposed grasps. The first plurality of quality scores may represent a first plurality of likelihoods of success corresponding to the first plurality of proposed grasps.

Other features and advantages of various aspects and embodiments of the present invention will become apparent from the following description and from the claims.

### BRIEF DESCRIPTION OF THE DRAWINGS

FIG. 1 is a dataflow diagram of a system for enabling a robot arm to grasp objects according to one embodiment of the present invention;

FIG. 2 is a flowchart of a method performed by the system of FIG. 1 according to one embodiment of the present invention;

FIG. 3 is a dataflow diagram of a system for generating and evaluating proposed robot arm grasps according to one embodiment of the present invention; and

FIG. 4 is a flowchart of a method performed by the system of FIG. 3 according to one embodiment of the present invention.

### DETAILED DESCRIPTION

Embodiments of the present invention use a combination of supervised learning (SL) and reinforcement learning (RL) techniques to improve the grasping (e.g., two-finger grasping) of objects by robot arms. During experimentation it has been found, for example, that embodiments of the present invention may be used to achieve high grasping accuracy on cluttered, real-world scenes, after only a few hours of interaction between the robot and the environment. This represents a significant advance over state-of-the-art techniques for enabling a robot arm to grasp objects.

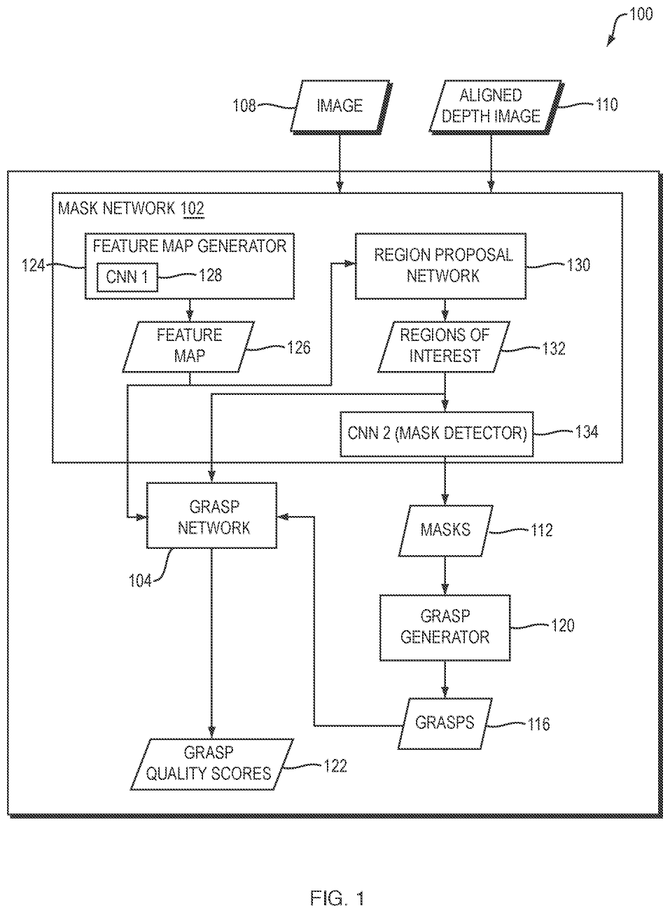

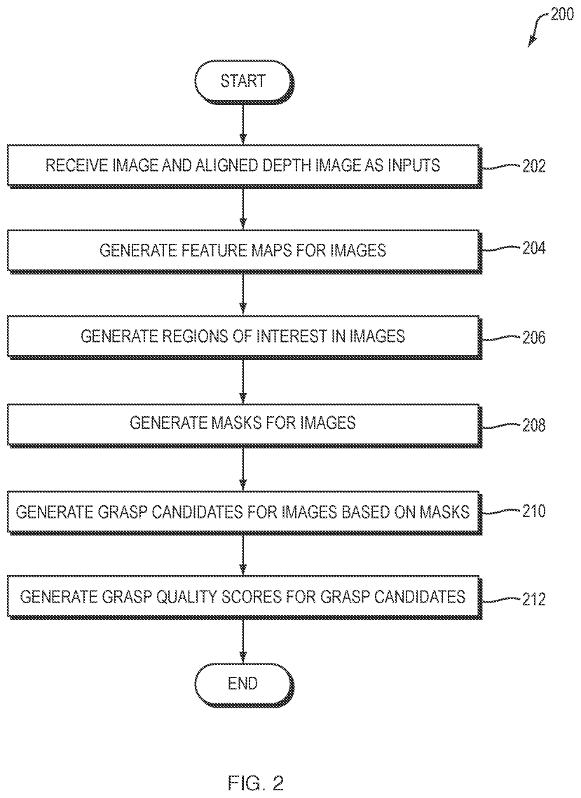

Referring to FIG. 1, a dataflow diagram is shown of a system 100 for enabling a robot arm (not shown) to grasp objects (not shown) according to one embodiment of the present invention. Referring to FIG. 2, a flowchart is shown of a method 200 performed by the system 100 of FIG. 1 according to one embodiment of the present invention. Embodiments of the present invention may be used in connection with any of a variety of robot arms and any of a variety of objects, none of which are limitations of the present invention.

The system 100 receives as inputs an image 108 (e.g., an RGB image) and an aligned depth image 110 (FIG. 2, operation 202). The image 108 is an image of a real-world scene containing one or a plurality of objects to be grasped by the robot arm. The objects in the scene may be the same as, similar to, or dissimilar from each other in any way and any combination. The aligned depth image 110 contains data representing depths of one or more positions (e.g., pixels) in the image 108. Positions in the aligned depth image 110 are “aligned” in the sense that they are aligned to corresponding positions in the image 108, in order to enable the depth data in the aligned depth image 110 to be used to identify depths of positions in the image 108. The image 108 and aligned depth image 110 may be generated, represented, and stored in any of a variety of ways, including ways that are well-known to those having ordinary skill in the art.

The system 100 produces as outputs: (1) a set of masks 112 over some or all of the objects in the image 108 (where each of the masks 112 corresponds to a distinct one of the objects in the image 108); (2) a set of classifications for the masks 112 (e.g., one classification corresponding to each of the masks 112); (3) a set of proposed antipodal grasps 116 for the masks 112 (e.g., one grasp corresponding to each of the masks 112), where each of the antipodal grasps 116 may, for example, be represented as two pixels on the input image 108, where each of the two pixels corresponds to a desired position of a corresponding gripper finger of the robot arm; and (4) a set of grasp quality scores 122 (e.g., values in the range [0,1], also referred to herein as grasp scores), one for each of the proposed grasps 116, where each of the grasp quality scores 122 represents a probability that the corresponding one of the proposed grasps 116 will be successful if attempted by the robot arm.

Having described the inputs and outputs of the system 100 of FIG. 1, the components and operation of embodiments of the system 100 will now be described. The system 100 includes both a mask network 102 and a grasp network 104. The mask network 102 may, for example, be implemented at least in part, using the Mask R-CNN architecture. Although the Mask R-CNN architecture is well-known to those having ordinary skill in the art in general, the particular use of the Mask R-CNN architecture in embodiments of the present invention is not previously known. For example, the mask network 102 may use existing techniques from the Mask R-CNN architecture to generate masks 112 for the objects in the image 108 by using a feature map generator 124, which receives the image 108 and aligned depth image 110 as inputs, and transforms the image 108 into a feature map 126 using a first convolutional neural network (CNN) 128 (FIG. 2, operation 204). The mask network 102 may also include a region proposal network (RPN) 130 (which is another known aspect of the Mask R-CNN architecture) to locate, and generate as output, regions of interest (ROI) 132 in the feature map 126 that correspond to the locations of objects in the input image 108 (FIG. 2, operation 206). The mask network 102 may pass these regions of interest 132 into a second CNN 134, referred to as a “mask detector,” which produces the masks 112 for the objects in the input image 108 (FIG. 2, operation 208). Note, however, that embodiments of the present invention may generate the masks 112 in any way; using the mask detector 134 to generate the masks 112 is merely one example and is not a limitation of the present invention.

The system 100 includes a grasp generator 120, which receives the masks 112 as input and generates a set of proposed grasps 116 based on the masks 112 (e.g., one proposed grasp per mask, and therefore one proposed grasp per object in the image 108) (FIG. 2, operation 210). The grasp generator 120 may first convert each of the masks 112 into a cloud of two-dimensional points. Each such point cloud may be centered at the origin, where a unit vector v and its orthogonal vector u are rotated k times between 0 and 90 degrees. For each of these k rotations, every point in the mask's point cloud, within some specified distance of the line defined by v and the origin, is placed in a set X. The distance between the origin and each point in the set X is then computed. The two points farthest from the origin, chosen on opposite sides of u, are then selected to be the proposed grasp for the mask, where each point represents the desired position for each gripper finger.

The system 100 extends the existing Mask R-CNN architecture by including an additional CNN, referred to herein as the grasp network 104, which may execute in parallel with the mask detector 134, and which may operate directly on the ROIs 132 generated by the region proposal network 130 and on the feature map 126. The grasp network receives a number of ROIs (from the set of ROIs 132) corresponding to objects in the image 108 and a set of proposed grasps for that object (from the set of proposed grasps 116). For each such ROI-grasp pair, the grasp network 104 predicts the probability that the grasp would succeed (e.g., pick up the object and not drop it while moving) if attempted by the robot arm. The grasp network 104 uses such probabilities to generate grasp quality scores 122 (FIG. 2, operation 212). The grasp network 104 may generate the grasp quality scores 122 based on the probabilities in any of a variety of ways, such as by using each probability as the activation value of a single neural network neuron, passed through a sigmoid function. In some embodiments, the grasp network 104 may exclude grasp quality scores 122 which correspond to grasps that are outside the robot's safety limits.

The system 100 may, for example, be trained as follows. Because the masks 112 must be generated before the grasp generator 120 can generate the proposed grasps 116, the system 100 may be trained in two stages. First, human labelers may provide ground truth masks on a set of images, which are then used as prediction targets to train the feature map generator 124, the region proposal network 130, and the mask detector 134. Second, the mask network 102 and grasp generator 120 may be used together to propose grasps 116, which are then chosen at random, and attempted by the robot arm on the objects shown in the image 108. The resulting RGB+D images, attempted grasps, and an indicator of whether the attempted grasp was successful may then be stored in a dataset. Finally, the grasp network 104 may be trained to perform classification on these image-grasp pairs, thereby learning to predict, for novel pairings, whether or not the grasp will succeed. During testing, the entire system 100 may then be used to predict masks, generate multiple grasp candidates per mask, and use the grasp network to evaluate all of the grasp candidates 116, and to select only the best one of the grasp candidates 116 to be executed by the robot arm.

A significant contribution of embodiments of the present invention is that they may use the masks 112 as a source of prior information for generating the proposed grasps 116. Using the masks 112 significantly reduces the search space for good grasps, thereby allowing the grasp network 104 to evaluate and choose from among only a small number of grasp candidates 116, which are already likely to succeed. This approach stands in contrast to existing state-of-the-art methods, such as the “cross entropy method,” which generate grasp candidates almost entirely at random, and which therefore require evaluation of a much larger number of grasp candidates than embodiments of the present invention. Embodiments of the present invention include a novel combination of Mask R-CNN and grasp quality estimation in a single architecture and demonstrate that masks can be used to improve grasping.

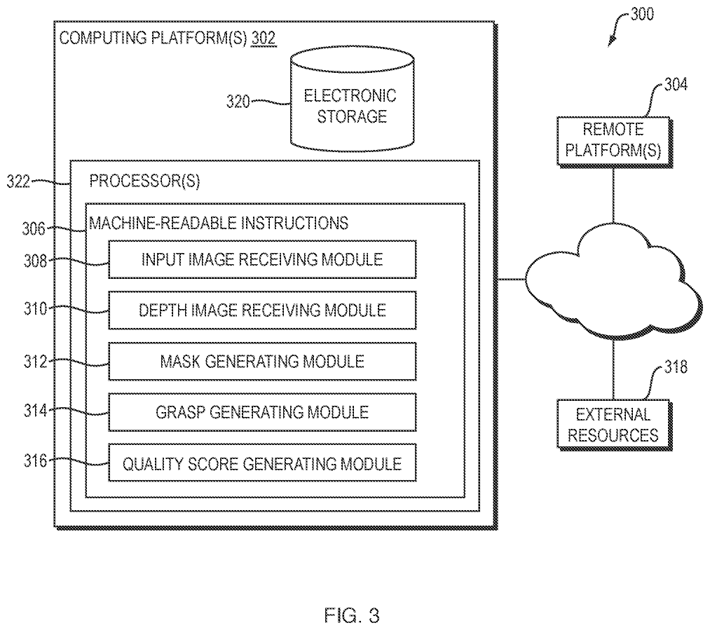

FIG. 3 illustrates a system 300 configured for generating and evaluating a first plurality of proposed grasps corresponding to a first object, in accordance with one or more embodiments. In some embodiments, system 300 may include one or more computing platforms 302. Computing platform(s) 302 may be configured to communicate with one or more remote platforms 304 according to a client/server architecture, a peer-to-peer architecture, and/or other architectures. Remote platform(s) 304 may be configured to communicate with other remote platforms via computing platform(s) 302 and/or according to a client/server architecture, a peer-to-peer architecture, and/or other architectures. Users may access system 300 via remote platform(s) 304.

Computing platform(s) 302 may be configured by machine-readable instructions 306. Machine-readable instructions 306 may include one or more instruction modules. The instruction modules may include computer program modules. The instruction modules may include one or more of input image receiving module 308, depth image receiving module 310, mask generating module 312, grasp generating module 314, quality score generating module 316, and/or other instruction modules.

Input image receiving module 308 may be configured to receive a input image (such as the input image 108) representing the first object. The input image may further represent a second object.

Depth image receiving module 310 may be configured to receive an aligned depth image (such as the aligned depth image 110) representing depths of a plurality of positions in the input image. Generating, based on the input image and the aligned depth image, a first mask may correspond to the first object further includes generating, based on the input image and the aligned depth image, a second mask corresponding to the second object. Generating, based on the input image and the aligned depth image, a first mask corresponding to the first object may include generating, based on the input image and the aligned depth image, a plurality of regions of interest in the input image. Generating, based on the input image and the aligned depth image, a first mask corresponding to the first object may include generating the first mask based on the plurality of regions of interest in the input image. Generating the first mask based on the plurality of regions of interest in the input image may include using a convolutional neural network to generate the first mask based on the plurality of regions of interest in the input image.

Mask generating module 312 may be configured to generate, based on the input image and the aligned depth image, a first mask corresponding to the first object.

Grasp generating module 314 may be configured to generate, based on the first mask, the first plurality of proposed grasps (such as the proposed grasps 116) corresponding to the first object.

Quality score generating module 316 may be configured to generate, based on the first plurality of proposed grasps, a first plurality of quality scores (such as the grasp quality scores 122) corresponding to the first plurality of proposed grasps. The first plurality of quality scores may represent a first plurality of likelihoods of success corresponding to the first plurality of proposed grasps. Generating, based on the first mask, the first plurality of proposed grasps corresponding to the first object further includes generating, based on the second mask, a second plurality of proposed grasps corresponding to the second object. Generating, based on the first plurality of proposed grasps, a first plurality of quality scores corresponding to the first plurality of proposed grasps may further include generating, based on the second plurality of proposed grasps, a second plurality of quality scores corresponding to the second plurality of proposed grasps. Each grasp, in the first plurality of proposed grasps, may include data representing a pair of pixels in the input image corresponding to a first and second position, respectively, for a first and second gripper finger of a robot.

Generating, based on the first plurality of proposed grasps, a first plurality of quality scores corresponding to the first plurality of proposed grasps may include generating, based on the input image, a feature map (such as the feature map 126). Generating, based on the first plurality of proposed grasps, a first plurality of quality scores corresponding to the first plurality of proposed grasps may include generating the first plurality of quality scores based on the feature map and the plurality of regions of interest in the input image. Generating, based on the input image, a feature map may include using a convolutional neural network to generate the feature map. Generating the first plurality of quality scores based on the feature map and the plurality of regions of interest in the input image may include using a convolutional neural network to generate the first plurality of quality scores. Generating the first mask based on the plurality of regions of interest in the input image and generating the first plurality of quality scores based on the feature map and the plurality of regions of interest in the input image may be performed in parallel with each other.

In some embodiments, the second plurality of quality scores may represent a second plurality of likelihoods of success corresponding to the second plurality of proposed grasps.

In some embodiments, computing platform(s) 302, remote platform(s) 304, and/or external resources 318 may be operatively linked via one or more electronic communication links. For example, such electronic communication links may be established, at least in part, via a network such as the Internet and/or other networks. It will be appreciated that this is not intended to be limiting, and that the scope of this disclosure includes embodiments in which computing platform(s) 302, remote platform(s) 304, and/or external resources 318 may be operatively linked via some other communication media.

A given remote platform 304 may include one or more processors configured to execute computer program modules. The computer program modules may be configured to enable an expert or user associated with the given remote platform 304 to interface with system 300 and/or external resources 318, and/or provide other functionality attributed herein to remote platform(s) 304. By way of non-limiting example, a given remote platform 304 and/or a given computing platform 302 may include one or more of a server, a desktop computer, a laptop computer, a handheld computer, a tablet computing platform, a NetBook, a Smartphone, a gaming console, and/or other computing platforms.

External resources 318 may include sources of information outside of system 300, external entities participating with system 300, and/or other resources. In some embodiments, some or all of the functionality attributed herein to external resources 318 may be provided by resources included in system 300.

Computing platform(s) 302 may include electronic storage 320, one or more processors 322, and/or other components. Computing platform(s) 302 may include communication lines, or ports to enable the exchange of information with a network and/or other computing platforms. Illustration of computing platform(s) 302 in FIG. 3 is not intended to be limiting. Computing platform(s) 302 may include a plurality of hardware, software, and/or firmware components operating together to provide the functionality attributed herein to computing platform(s) 302. For example, computing platform(s) 302 may be implemented by a cloud of computing platforms operating together as computing platform(s) 302.

Electronic storage 320 may comprise non-transitory storage media that electronically stores information. The electronic storage media of electronic storage 320 may include one or both of system storage that is provided integrally (i.e., substantially non-removable) with computing platform(s) 302 and/or removable storage that is removably connectable to computing platform(s) 302 via, for example, a port (e.g., a USB port, a firewire port, etc.) or a drive (e.g., a disk drive, etc.). Electronic storage 320 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 320 may include one or more virtual storage resources (e.g., cloud storage, a virtual private network, and/or other virtual storage resources). Electronic storage 320 may store software algorithms, information determined by processor(s) 322, information received from computing platform(s) 302, information received from remote platform(s) 304, and/or other information that enables computing platform(s) 302 to function as described herein.

Processor(s) 322 may be configured to provide information processing capabilities in computing platform(s) 302. As such, processor(s) 322 may include one or more of a digital processor, an analog processor, a digital circuit designed to process information, an analog circuit designed to process information, a state machine, and/or other mechanisms for electronically processing information. Although processor(s) 322 is shown in FIG. 3 as a single entity, this is for illustrative purposes only. In some embodiments, processor(s) 322 may include a plurality of processing units. These processing units may be physically located within the same device, or processor(s) 322 may represent processing functionality of a plurality of devices operating in coordination. Processor(s) 322 may be configured to execute modules 308, 310, 312, 314, and/or 316, and/or other modules. Processor(s) 322 may be configured to execute modules 308, 310, 312, 314, and/or 316, and/or other modules by software; hardware; firmware; some combination of software, hardware, and/or firmware; and/or other mechanisms for configuring processing capabilities on processor(s) 322. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 308, 310, 312, 314, and/or 316 are illustrated in FIG. 3 as being implemented within a single processing unit, in embodiments in which processor(s) 322 includes multiple processing units, one or more of modules 308, 310, 312, 314, and/or 316 may be implemented remotely from the other modules. The description of the functionality provided by the different modules 308, 310, 312, 314, and/or 316 described below is for illustrative purposes, and is not intended to be limiting, as any of modules 308, 310, 312, 314, and/or 316 may provide more or less functionality than is described. For example, one or more of modules 308, 310, 312, 314, and/or 316 may be eliminated, and some or all of its functionality may be provided by other ones of modules 308, 310, 312, 314, and/or 316. As another example, processor(s) 322 may be configured to execute one or more additional modules that may perform some or all of the functionality attributed below to one of modules 308, 310, 312, 314, and/or 316.

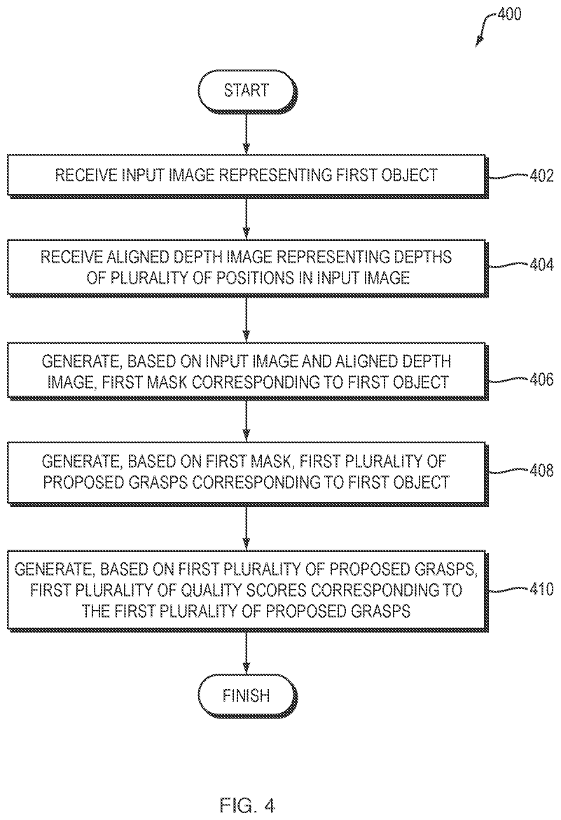

FIG. 4 illustrates a method 400 for generating and evaluating a first plurality of proposed grasps corresponding to a first object, the, in accordance with one or more embodiments. The operations of method 400 presented below are intended to be illustrative. In some embodiments, method 400 may be accomplished with one or more additional operations not described, and/or without one or more of the operations discussed. Additionally, the order in which the operations of method 400 are illustrated in FIG. 4 and described below is not intended to be limiting.

In some embodiments, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

An operation 402 may include receiving a input image representing the first object. Operation 402 may be performed by one or more hardware processors configured by machine-readable instructions including a module that is the same as or similar to input image receiving module 308, in accordance with one or more embodiments.

An operation 404 may include receiving an aligned depth image representing depths of a plurality of positions in the input image. Operation 404 may be performed by one or more hardware processors configured by machine-readable instructions including a module that is the same as or similar to depth image receiving module 310, in accordance with one or more embodiments.

An operation 406 may include generating, based on the input image and the aligned depth image, a first mask corresponding to the first object. Operation 406 may be performed by one or more hardware processors configured by machine-readable instructions including a module that is the same as or similar to mask generating module 312, in accordance with one or more embodiments.

An operation 408 may include generating, based on the first mask, the first plurality of proposed grasps corresponding to the first object. Operation 408 may be performed by one or more hardware processors configured by machine-readable instructions including a module that is the same as or similar to grasp generating module 314, in accordance with one or more embodiments.

An operation 410 may include generating, based on the first plurality of proposed grasps, a first plurality of quality scores corresponding to the first plurality of proposed grasps. The first plurality of quality scores may represent a first plurality of likelihoods of success corresponding to the first plurality of proposed grasps. Operation 410 may be performed by one or more hardware processors configured by machine-readable instructions including a module that is the same as or similar to quality score generating module 316, in accordance with one or more embodiments.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Although certain embodiments disclosed herein are applied to two-finger robot arms, this is merely an example and does not constitute a limitation of the present inventions. Those having ordinary skill in the art will understand how to apply the techniques disclosed herein to robots having two, three, four, or more fingers.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, the neural networks used by embodiments of the present invention, such as the CNN 128 and the mask detector 134, may be applied to datasets containing millions of elements and perform up to millions of calculations per second. It would not be feasible for such algorithms to be executed manually or mentally by a human. Furthermore, it would not be possible for a human to apply the results of such learning to control a robot in real time.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A method, performed by at least one computer processor executing computer program instructions stored on at least one non-transitory computer-readable medium, for generating and evaluating a first plurality of proposed grasps corresponding to a first object, the method comprising:
(A) receiving a input image representing the first object;
(B) receiving an aligned depth image representing depths of a plurality of positions in the input image;
(C) generating, based on the input image and the aligned depth image, a first mask corresponding to the first object;
(D) generating, based on the first mask, the first plurality of proposed grasps corresponding to the first object; and
(E) generating, based on the first plurality of proposed grasps, a first plurality of quality scores corresponding to the first plurality of proposed grasps, the first plurality of quality scores representing a first plurality of likelihoods of success corresponding to the first plurality of proposed grasps.

2. The method of claim 1:
wherein the input image further represents a second object,
wherein (C) further comprises generating, based on the input image and the aligned depth image, a second mask corresponding to the second object;
wherein (D) further comprises generating, based on the second mask, a second plurality of proposed grasps corresponding to the second object; and
wherein (E) further comprises generating, based on the second plurality of proposed grasps, a second plurality of quality scores corresponding to the second plurality of proposed grasps, the second plurality of quality scores representing a second plurality of likelihoods of success corresponding to the second plurality of proposed grasps.

3. The method of claim 1, wherein each grasp, in the first plurality of proposed grasps, comprises data representing a pair of pixels in the input image corresponding to a first and second position, respectively, for a first and second gripper finger of a robot.

4. The method of claim 1, wherein (C) comprises:
(C)(1) generating, based on the input image and the aligned depth image, a plurality of regions of interest in the input image; and
(C)(2) generating the first mask based on the plurality of regions of interest in the input image.

5. The method of claim 4, wherein (C)(2) comprises using a convolutional neural network to generate the first mask based on the plurality of regions of interest in the input image.

6. The method of claim 4, wherein (E) comprises:
(E)(1) generating, based on the input image, a feature map; and
(E)(2) generating the first plurality of quality scores based on the feature map and the plurality of regions of interest in the input image.

7. The method of claim 6, wherein (E)(1) comprises using a convolutional neural network to generate the feature map.

8. The method of claim 6, wherein (E)(2) comprises using a convolutional neural network to generate the first plurality of quality scores.

9. The method of claim 6, wherein (C)(2) and (E)(2) are performed in parallel with each other.

10. A system comprising at least one non-transitory computer-readable medium containing computer program instructions which, when executed by at least one computer processor, perform a method for generating and evaluating a first plurality of proposed grasps corresponding to a first object, the method comprising:
(A) receiving a input image representing the first object;
(B) receiving an aligned depth image representing depths of a plurality of positions in the input image;
(C) generating, based on the input image and the aligned depth image, a first mask corresponding to the first object;
(D) generating, based on the first mask, the first plurality of proposed grasps corresponding to the first object; and
(E) generating, based on the first plurality of proposed grasps, a first plurality of quality scores corresponding to the first plurality of proposed grasps, the first plurality of quality scores representing a first plurality of likelihoods of success corresponding to the first plurality of proposed grasps.

11. The system of claim 10:
wherein the input image further represents a second object,
wherein (C) further comprises generating, based on the input image and the aligned depth image, a second mask corresponding to the second object;
wherein (D) further comprises generating, based on the second mask, a second plurality of proposed grasps corresponding to the second object; and
wherein (E) further comprises generating, based on the second plurality of proposed grasps, a second plurality of quality scores corresponding to the second plurality of proposed grasps, the second plurality of quality scores representing a second plurality of likelihoods of success corresponding to the second plurality of proposed grasps.

12. The system of claim 10, wherein each grasp, in the first plurality of proposed grasps, comprises data representing a pair of pixels in the input image corresponding to a first and second position, respectively, for a first and second gripper finger of a robot.

13. The system of claim 10, wherein (C) comprises:
(C)(1) generating, based on the input image and the aligned depth image, a plurality of regions of interest in the input image; and
(C)(2) generating the first mask based on the plurality of regions of interest in the input image.

14. The system of claim 13, wherein (C)(2) comprises using a convolutional neural network to generate the first mask based on the plurality of regions of interest in the input image.

15. The system of claim 13, wherein (E) comprises:
(E)(1) generating, based on the input image, a feature map; and
(E)(2) generating the first plurality of quality scores based on the feature map and the plurality of regions of interest in the input image.

16. The system of claim 15, wherein (E)(1) comprises using a convolutional neural network to generate the feature map.

17. The system of claim 15, wherein (E)(2) comprises using a convolutional neural network to generate the first plurality of quality scores.

18. The system of claim 15, wherein (C)(2) and (E)(2) are performed in parallel with each other.
